(19) United States
(12) Patent Application Publication
(10) Pub. No.: US 2019/0133358 A1
(43) Pub. Date: May 9, 2019

(54) Bottle with insulated chamber and internal storage for cups and accessories

(71) Applicants: Christopher Joseph Clyde, San Antonio, TX (US); Jose Roberto Hinjosa, San Antonio, TX (US)

(72) Inventors: Christopher Joseph Clyde, San Antonio, TX (US); Jose Roberto Hinjosa, San Antonio, TX (US)

(21) Appl. No.: 15/614,554

(22) Filed: Jun. 5, 2017

Related U.S. Application Data
(60) Provisional application No. 62/345,852, filed on Jun. 5, 2016.

(51) Int. Cl. A47G 23/02; B65D 1/02; B65D 1/04; B65D 1/06; B65D 41/04; A47G 19/22; A47G 19/23; B65D 81/20; B65D 81/38; B67B 7/00; B01F 3/04; B01F 5/04

(52) U.S. Cl. CPC A47G 23/0208; B01F 2215/0072; B65D 1/0276; B65D 1/04; B65D 1/06; B65D 41/04; A47G 19/2255; A47G 19/23; B65D 81/2015; B65D 81/3837; B67B 7/00; B01F 3/04794; B01F 5/0413; B01F 2003/04872; B65D 1/0246

(57) ABSTRACT

A shatter-resistant container in the shape of a large wine bottle with an insulated chamber. The container is designed for use in an area such as a pool or beach where glass is restricted. The container has a removable neck which permits a full bottle of wine to be poured quickly into a large opening in the insulated chamber. A base can be removed to access a storage compartment which holds a pair of disassembled stemmed wine glasses or stemless glasses made of a shatter-resistant polymer. The neck includes a cap or valve and an aerator, so that wine is aerated as it is poured from the container.

### RELATED APPLICATIONS

This US Non-Provisional patent application is related to U.S. Provisional Application No. 62/345,852 filed by applicants on Jun. 5, 2016, and claims the benefit of that filing date.

### BACKGROUND

### Field of the Invention

The present invention relates generally to devices and methods used for storing, carrying, and serving fluids. More particularly, the present invention relates to an insulated chamber for holding potable liquids such as wine, an internal storage chamber for holding cups or accessories, methods to pour, aerate, and serve the contents from the insulated chamber, and methods to access the internal storage chamber containing cups and/or accessories.

### Prior Art

Currently, the ability to enjoy wine outdoors in public or private spaces can be difficult, and can involve tradeoffs that ultimately lessen or compromise the full enjoyment of drinking and sharing wine. Outdoor spaces often limit the choice of material used, choice of equipment available, the quality and ability to follow the unique and rich traditions of wine. The outdoors can impose numerous environmental settings like high temperatures or rough terrain that require careful consideration for transporting wine. For the wine connoisseur and enthusiast, the outdoors pose numerous challenges that make it cumbersome, unpredictable, and problematic to achieve the same elegant wine drinking experience as enjoyed at home or in a controlled setting.

These tradeoffs begin with the selection of a wine. Wine is traditionally sold and stored in glass bottles. The more common glass bottles can be identified by one of three shapes (Burgundy, Bordeaux, and Alsace) and with a standard volume of 750 ml, with the Bordeaux being the most popular and recognized wine bottle shapes with a distinctive shoulder and neck. The Bordeaux bottle profile has become the universal symbol of wine. Glass bottles are the de-facto standard for wine storage, but they do have limited durability and protection against impact or from mishandling. If broken, the glass fragments can pose a harm or hazard to humans and animals which results in glass being prohibited from public spaces like pools, beaches, lakes, and parks. Alternatives to glass exist like “Box Wine” (a rigid paper box pre-filled with an internal bladder of wine) or plastic containers. Box wine tends to be a less common, low cost product, and sold in containers with higher volume capacities (3-5 liters). It offers fewer choices of style, origins, and quality, and is often only available in impractical capacity compared to the traditional Bordeaux glass bottles. There are smaller volume plastic alternatives called single-serve products like Copa di Vino® or Zipz® but they offer even less choice, quality, and volume. For wine connoisseurs, box wine and single-serve options do not offer enough varietal choice, quality, or come in sizes that are practical for more traditional enjoyment. Worse, their very size and shape breaks from the iconic Bordeaux bottle profile and undermines the rich and idealized wine experience of drinking wine poured from a bottle into a wine glass.

Like the bottle, glassware (or stemware) for wine has a recognized set of qualities designed to enhance the overall wine drinking experience. Traditionally they are made of clear glass and feature a well-defined bowl shape, and often a stem and base. But glass as a material for glassware poses the same hazard outdoors as did the glass bottle. Alternatives like paper or plastic utility cups exist like Dixie® or Solo®, but come with many limitations. They have an obvious social stigma which makes their use embarrassing as a wine cup. Additionally, the shape and non-transparent material limits the ability to see the wine color and detect subtle aromas. By contrast, the traditional transparent wine glass is an iconic symbol and tool whose shape and design are used by wine connoisseurs to visually inspect the color, and viscosity of wine, with a stem to provide a means to hold and reduce the warming of the bowl, and base to provide a means for standing the bowl upright.

Drinking wine has a long and established tradition that is easily recognized by the way it is consumed. Wine connoisseurs and enthusiast share in a common set of standards and practices for drinking wine that have become part of the overall culture and mystique of wine. Awareness and adherence to these protocols can be seen in the choice of glassware or the sometimes fanatical effort used to maintain tradition wherever possible. Changes that run contrary to that tradition are met with resistance within the culture. For example, serving wine out of a box, while appearing practical, has a strong negative stigma attached. Similar, the use of non-traditional and opaque cups like a red Dixie® cup, even if necessary to avoid glass, have a strong negative connotation. For wine enthusiast, great effort is made to avoid as many traditional and cultural faux pas as possible and this is easily achieved by pouring wine from a traditional wine bottle shape into a traditional and transparent wine glass.

Wine is sensitive to temperature. Most wine connoisseurs recommend wine to be served within a specific temperature range of 45-65 degrees F. depending on if it is white or red wine. This is the ideal range to reveal the character, aroma, and overall taste experience. When wine is exposed outside this ideal range, it can destroy the subtle flavor characteristics or result in the rapid breakdown of the wine. Wine connoisseurs take great effort to ensure the wine is kept at this ideal range for the entire life-cycle or duration of the drinking experience. Techniques or devices like pre-chilling wine or using ice buckets are common methods to help maintain wine within the ideal temperature range. When outdoors, these simple techniques or devices can be hard to regulate temperature consistently, can require extra equipment, and can be inconvenient in remote locations like pools, beaches, lakes, or parks. In such locations, wine enthusiast simply forgo wine as a beverage option choosing not to risk ruin or spoilage of the wine.

The unique complexities of wine can be enhanced through the use of aerating elements or exposing the wine to air prior to consuming. Wine connoisseurs often use aerating elements to aerate wine as a method to open up wines, soften tannins, or balance the complexity and unique flavor profiles. Aeration can be done by pouring wine into a separate container, which exposes the wine to air. This method is called decanting. Such methods are not immediate and require time and a secondary container before its effects are noted. Other aerating elements and methods exist which have an immediate effect. These aerating elements and methods attempt to aerate the wine quickly by either a vortex or venturi effect. Brands like Rabbit® and Soiree™ use a vortex aerating element method to swirl or agitate wine, while the aerating element or device called the Vinturi®, disclosed in U.S. Pat. No. 7,614,614 uses a venturi effect to merge air and wine together. These aerating elements and methods are separate devices and are not integral to the original container of wine, each requiring additional forethought, expense, and in some cases careful hand and eye coordination. Further, some aerating elements require special care to ensure wine is not spilled, by controlling the rate and direction of wine as it is poured from the container and into the aerating device. The consequence or poor management of the aerating element can lead to unwanted waste, spillage or staining of wine as it is aerated. A third element like a funnel can be used to mitigate this risk at additional expense.

Accordingly, a need exists for an apparatus and method to allow wine to be consumed in unpredictable, uncontrolled, or difficult spaces (whether public, private, or commercial) such as outdoors, beaches, parks, pools, rivers, boats, lakes, trails, camping, hiking, mountains, outdoor concert events, outside weddings, patios, fares, and other locations which make consumption otherwise a challenge. The apparatus and method should eliminate compromises, facilitate ease of use, avoid prohibited materials, embody the cultural and traditional rituals, and extend time and place of enjoyment in a manner similar to that enjoyed and experienced in a controlled space like the home, restaurant or wine bar. In the various example embodiments described below, these shortcomings are overcome through techniques such as the use of a shatter-resistant material; a recognized and traditional wine bottle shape; the ability to hold at least 750 ml of wine; a method to insulate the wine from external heat sources and slow or regulate internal temperature fluctuations; an aerating element integral to the container providing a method of aeration on-demand without need for forethought, separate coordination or control; and a storage compartment that can hold glassware and other useful accessories. These elements are embodied in a single, portable, and convenient container kit. Further, the embodiments provide an all-inclusive device and method for connoisseur or enthusiast to maintain with the upmost ease and elegance befitting the traditions of the wine drinking experience.

### BRIEF SUMMARY

In one embodiment, devices and methods are used for transporting, storing, dispensing, carrying, or serving wine or other fluids; and for conveniently storing cups and other accessories. In one example, portable containers made of resilient materials such as plastics, co-poly polyesters, or metals are used for transporting, storing, dispensing, carrying, and serving potable fluids such as, but not limited to, wine, juice or water. The containers have a storage compartment for storing, transporting, and retrieving cups or glasses or accessories.

In another embodiment, the portable container has an aerating element integral to the device providing aeration of the fluids as the fluid flows from an inner chamber outward toward an opening which can be sealed by a cap, lid, or valve.

In another embodiment, the device has both a storage compartment and an aerating element.

In one example, a shatter-resistant bottle apparatus provides a water-tight insulated chamber for holding the contents of a bottle of wine such that the fluid contents are insulated from external heat and maintains or slows the change of the internal fluid temperature and an internal storage compartment in the apparatus stores cups or glasses for drinking the wine. The cups or “glass” assemblies are provided in a manner allowing two or more shatter-resistant and BPA-Free plastic—such as Tritan™ glass bowls whose material is clear and glass-like in appearance to provide a pleasant drinking experience.

In one example, the device is shaped like a large wine bottle—such as a Bordeaux bottle so that wine can be poured from the insulated chamber through an aeration element integral to the device (such as within the neck of the device) in order to provide aeration of the fluid and replicate a pleasant pouring and wine-drinking experience at a poolside, beach, or other location where glass wine bottles and drinking glasses are prohibited or impractical. The device is such that the user has the additional benefit of opening, closing, or pouring from the neck assembly independently of the need to access the bottom of the device to access cups or plastic glass assemblies.

In one example, the user can fill, consume, and refill multiple times, the insulated chamber with a wine or other fluid of choice. In other examples, the device may be used, sold, lent, loaned, gifted, borrowed, or rented pre-filled with wine or other fluids (either as a one-time event or such that it may be consumed and returned for future refill), such as provided by a hotel, bar, restaurant, event, or winery.

In some embodiments, the devices include a vacuum-sealed insulated upper chamber for holding a fluid, and a lower storage compartment for cups, drinking glass assemblies, and accessories such as a wine bottle opener, cooling accessory such as a gel pack, or secondary fluid storage. In one example, the insulated chamber is located below a removable neck, and a large top opening in the insulated chamber permits rapid filling from a wine bottle. The neck includes a second, smaller opening with a cap, lid or valve. The smaller neck opening is used to pour the contents from the insulated chamber into a plurality of cups or glasses. The top cap, lid, or valve provides a visual indication of open or closed state to facilitate leak-proof transport and use.

In other embodiments, the fluid chamber may use other insulation methods either in combination or independently—such as an air gap, foam material, radiant (such as infra-red or heat source) reflective material like a-aluminum Mylar® sheath, or via the intrinsic insulation properties provided by the liquid chamber and outer shell of the device. The chamber or separate cooling device may be stored in a refrigerator or freezer prior to filling, so that the contents remain cool for a longer time before use.

In other embodiments, the fluid chamber is positioned below an upper storage compartment.

In other embodiments, no storage compartment is provided.

In some embodiments, a custom carry bag is provided to add seasonal, holiday, activity or fashion-focused utility to hold the device, snacks, and other accessories, such as a wine bottle opener.

### BRIEF DESCRIPTION OF THE DRAWINGS

FIG. 1 is a representative profile view of a portable storage device for wine and related wine accessories.

FIG. 2 is a perspective view of the first example embodiment of the portable storage device of FIG. 1.

FIG. 3 is an exploded profile view drawing of the first example embodiment of the portable storage device of FIG. 1.

FIG. 4 is an exploded cross profile view of the portable storage device of FIG. 1 taken along line B-B′.

FIG. 5 is a cross-sectional view of the device of FIG. 1 taken along line A-A′.

FIG. 6 is a representative profile view of a removable top assembly in FIG. 1.

FIG. 7 is a cross-sectional view of the removable top assembly in FIG. 1 taken along line C-C′ in FIG. 6.

FIG. 8 is a cross-sectional view of a first alternative example embodiment of the removable top assembly in FIG. 1 which shows an integrated venturi aeration device. This cross-sectional view was taken along line C-C′ in the representative profile view in FIG. 6.

FIG. 9 is a cross-sectional view of a second alternative embodiment of the removable top assembly in FIG. 1 which shows an alternative aeration device with o-ring and pop-up lid. This cross-sectional view was taken along line C-C′ in the representative profile view in FIG. 6.

FIG. 10 is a profile view of an alternative embodiment of the removable top assembly in FIG. 1.

FIG. 11 is a cross-sectional view of the alternative embodiment of the removable top assembly in FIG. 10 which shows a venturi aeration device and a spring-loaded pop-up lid assembly that is in the closed position. This cross-sectional view was taken along line D-D′ in the profile view in FIG. 10.

FIG. 12 is a cross-sectional view of the device of FIG. 11 with the spring-loaded lid in the open position.

FIG. 13 is a profile view of an alternative embodiment of the removable top assembly in FIG. 1.

FIG. 14 is a cross-sectional view of an alternative embodiment of the removable top assembly in FIG. 1 shown with a spring-loaded lid in the closed position. This cross-sectional view was taken along line E-E′ in the profile view in FIG. 13.

FIG. 15 is a similar cross-sectional view of alternative embodiment in FIG. 14 with the spring-loaded lid in the open position.

FIG. 16 is a perspective view of an alternative embodiment of the removable top assembly 120 in FIG. 1 shown with a hinged lid in the closed position.

FIG. 17 is a perspective view of an alternative embodiment of FIG. 16 with the hinged lid in the open position.

FIG. 18 is a profile view of an embodiment of a wine glass bowl.

FIG. 19 is a cross-sectional view of the wine glass bowl of FIG. 18. This cross-sectional view was taken along line F-F′ in the profile view in FIG. 18.

FIG. 20 is a profile view of an alternate embodiment of a wine glass bowl.

FIG. 21 is a cross-sectional view of the wine glass bowl of FIG. 20. This cross-sectional view was taken along line G-G′ in the profile view in FIG. 20.

FIG. 22 is a profile view of an alternate embodiment of a wine glass bowl.

FIG. 23 is a cross-sectional view of the wine glass bowl of FIG. 22. This cross-sectional view was taken along line H-H′ in the profile view in FIG. 22.

FIG. 24 is a profile view of an alternate embodiment of a wine glass bowl.

FIG. 25A is a cross-sectional view of the wine glass bowl of FIG. 24. This cross-sectional view was taken along line I-I′ in the profile view in FIG. 24.

FIG. 25B is a profile view of an alternate embodiment of a stemless wine glass bowl with a flat bottom.

FIG. 25C is a cross-sectional view of a stemless wine glass bowl with a flat bottom of FIG. 25B. This cross-sectional view was taken along line J-J′ in the profile view in FIG. 20.

FIG. 26 is a profile view of an embodiment of a wine glass stem and base assembly.

FIG. 27 is a cross-sectional view of the wine glass stem and base assembly of FIG. 26. This cross-sectional view was taken along line A-A′ in the profile view in FIG. 26.

FIG. 28 is a profile view of an embodiment of a wine glass stem and base assembly.

FIG. 29 is a cross-sectional view of the wine glass stem and base assembly of FIG. 28. This cross-sectional view was taken along line B-B′ in the profile view in FIG. 28.

FIG. 30A is a profile view of an embodiment of a wine glass stem and base assembly.

FIG. 30B is a cross-sectional view of the wine glass stem and base assembly of FIG. 30A. This cross-sectional view was taken along line C-C′ in the profile view in FIG. 30.

FIG. 31 is an exploded profile view drawing of the second example embodiment of the portable storage device of FIG. 1.

FIG. 32 is an exploded cross-sectional view drawing of the second example embodiment of the portable storage device of FIG. 1. This cross-sectional view was taken along line B-B′ in the exploded profile view in FIG. 31.

FIG. 33 is cross-sectional profile view of the second example embodiment of the portable storage device of FIG. 1. This cross-sectional view was taken along line A-A′ in the representative profile view drawing in FIG. 1.

FIG. 34A is a side view of an example embodiment of a portable storage device in a pouring orientation with a valve cap opened to permit wine to be poured from the device.

FIG. 34B is a side detail view of the example embodiment of FIG. 34A with the valve cap closed.

FIG. 34C is a side cross view of the example embodiment of FIG. 34A showing the valve cap and an aerator.

FIG. 34D is a detailed side cross view of the top portion of example embodiment of FIG. 34A.

FIG. 34E is an exploded side view of the example embodiment of FIG. 34A showing the top assembly and base removed from the central housing assembly.

FIG. 34F is a side view of top assembly of the example embodiment of FIG. 34A showing the valve cap in an open position so that wine may be poured through a top opening in the valve cap, and showing threads on the top assembly.

### DESCRIPTION OF EMBODIMENT

### Insulated Wine Storage Container with Lower Storage Compartment

### Definitions

In this specification, the term “aeration element” means features that enhance aeration of wine as it is poured into or out of the container. In some examples, prior art aeration products are incorporated into the wine storage container. In other examples, aeration features such as venturi elements are fabricated with the housing or other components so that the aeration features are integral to the to the upper neck portion of the container.

In this specification, the terms “glassware”, “stemware” or “glass” refers to a drinking glass, cup, or tumbler which may be provided in any plastic, paper, metal, or any other material. An example style is in the manner of a traditional wine glass comprising a bowl, stem, and base. Another style is a modern stemless cup such as a wine glass bowl with a flat bottom or trapezoid or conical shaped tumbler which can stand without spilling its contents.

In this specification, the terms “bottle” or “device” refer to various embodiments of a container with at least one fluid chamber with a separable upper neck and a cap, lid, or valve configured to cover the top opening.

In this specification, the term “insulated liquid storage compartment” refers to a fluid chamber that resists external heat gain. In one example, the fluid chamber has a double wall with a vacuum space between the walls. In another example, the fluid chamber includes a single wall and insulation provided on the outside of the wall. In another example, the insulation may include methods, alone or in combination, such as thermal reflecting material, foam-based material, or air gap.

In this specification, the term “separable” refers to removable or partially removable, such as hinged.

### LIST OF ELEMENTS

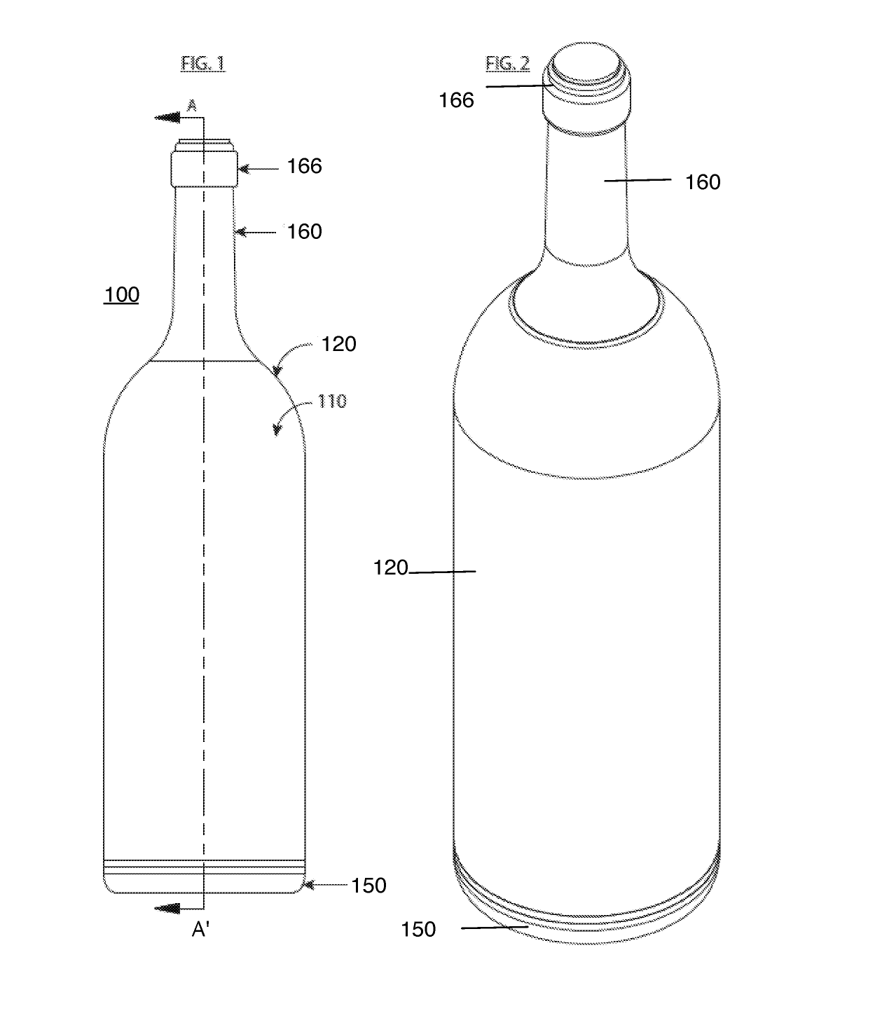

The following list of elements is provided for convenience in reviewing FIGS. 1-34.

### Device Embodiments 100, 101

Central housing assembly 120
insulated liquid storage compartment 130
   curved bottom 132
accessory storage compartment 140
   wine glass 200, 210, 220, 230, 260
      bowl 202, 212, 222, 232, 242, 245, 262
      stem 204, 214, 224, 234, 244, 264
      base 206, 216, 226, 236, 246, 266
   corkscrew 250

bottom 150
threads or quarter-turn closure 152

top assembly 160, 161, 162, 163, 164, 165, 174
quarter turn attachment element 190 (not shown)
threads 192
screw cap 166
valve cap 173
   opening 175
hinged lid 167
pop-up cap 168
   extension 169
spring loaded lid 180
venturi aeration device 170
alternative aeration device 171
pour spout 172

FIG. 1 is a profile view of a first example embodiment of a portable storage device 100 for wine and related wine accessories. FIG. 2 is a perspective view of the first example embodiment of the portable storage device of FIG. 1. In this embodiment, wine is stored in an insulated liquid storage compartment 130 (not shown) in a central housing assembly 120. A top assembly 160 may be opened or removed to fill the insulated liquid storage compartment. The top assembly includes a removable or flip-top cap 166 which may be opened to pour wine from the insulated liquid storage compartment. A bottom portion 150 may be removed or opened in order to access a storage compartment 154 (not shown).

In this example, the central housing assembly includes a cylindrical body section having a first diameter. The top assembly includes an upper neck section comprising a cylindrical bottom with a second diameter smaller that the first diameter, and a top opening having internal diameter. An internal channel is provided between between the lower portion of the upper neck section and the top opening of the upper neck section. A cap, lid or valve is configured to cover the top opening of the upper neck section.

A housing transition section between the cylindrical body section and the upper neck section has a convex portion integral to the cylindrical body section, and a concave portion integral to the upper neck section. The upper neck section is separable from the cylindrical body section at the intersection of the convex portion of the cylindrical body section and the concave portion of the the upper neck section.

FIG. 3 is an exploded profile view drawing of the first example embodiment of the portable storage device of FIG. 1. In this example, a flat bottom insulated liquid storage compartment 130, and an accessory storage compartment 140 are provided in the central housing assembly 120. In this example, the insulated liquid storage compartment 130 the insulated chamber is a vacuum-sealed insulated chamber positioned within an upper portion of the cylindrical body section. The insulated chamber has a capacity of at least 750 ml, and is positioned within the cylindrical body section of the housing. The insulated chamber has an upper opening aligned with the internal channel of the upper neck section. In some examples, the liquid storage compartment 130 has a concave bottom in order to increase the usable central height of storage compartment.

In this example, the portable storage device of FIG. 1 a storage compartment is provided within a lower portion the cylindrical body section of the housing. The storage compartment is accessed through a removable base. A pair of disassembled wine glasses 200 and 210 are stored in the accessory storage compartment with the bowls 202 and 212 inverted and stacked, and their stem and base assemblies (214 and 216) and (204 and 206) stored inside the lower bowl.

FIG. 3 is an exploded profile view drawing of the first example embodiment of the portable storage device of FIG. 1. In this example, a flat bottom insulated liquid storage compartment 130, and an accessory storage compartment 140 are provided in the central housing assembly 120. A pair of disassembled wine glasses 200 and 210 are stored in the accessory storage compartment with the bowls 202 and 212 inverted and stacked, and their stem and base assemblies (214 and 216) and (204 and 206) stored inside the lower bowl.

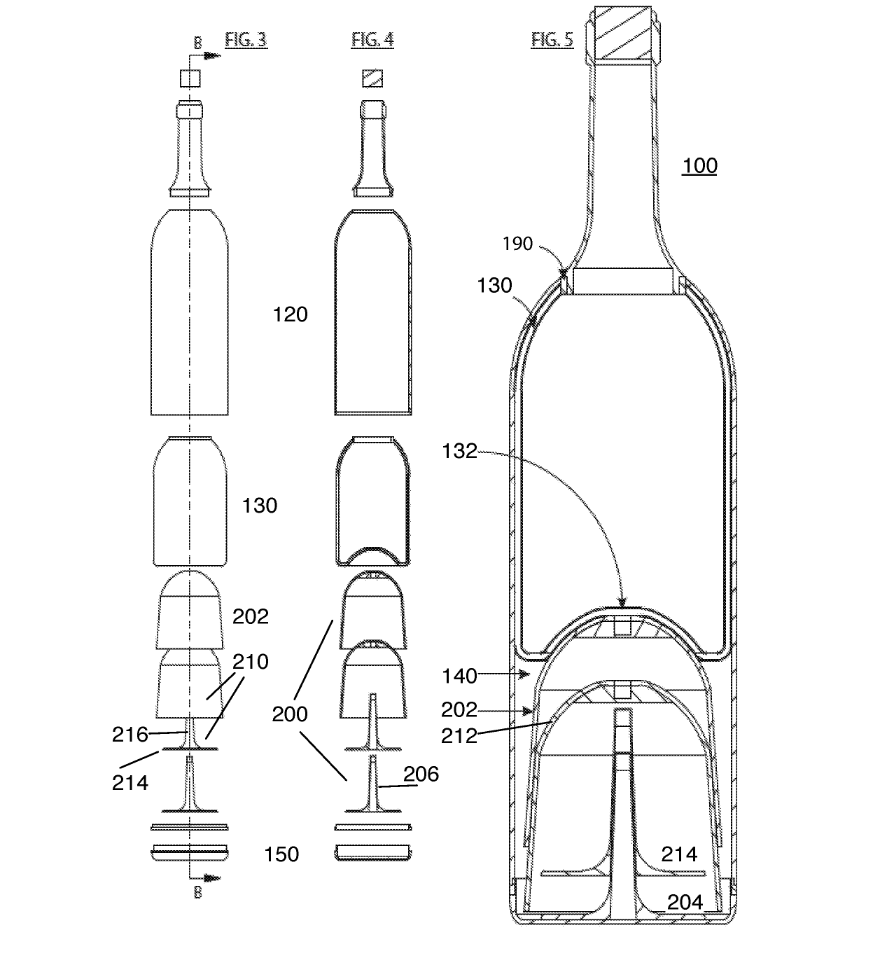

FIG. 4 is an exploded cross profile view of the portable storage device of FIG. 1 taken along line B-B′. FIG. 5 is a cross-sectional view of the device of FIG. 1 taken along line A-A′. FIG. 5 is a cross-sectional view of the device of FIG. 1 taken along line A-A′. FIG. 5 shows the nesting of the inverted wine glass bowl 212 in the curved bottom 132 of insulated liquid storage compartment 130.

Top Assembly

FIG. 6 is a representative profile view of a removable and water-tight top assembly 120 in FIG. 1.

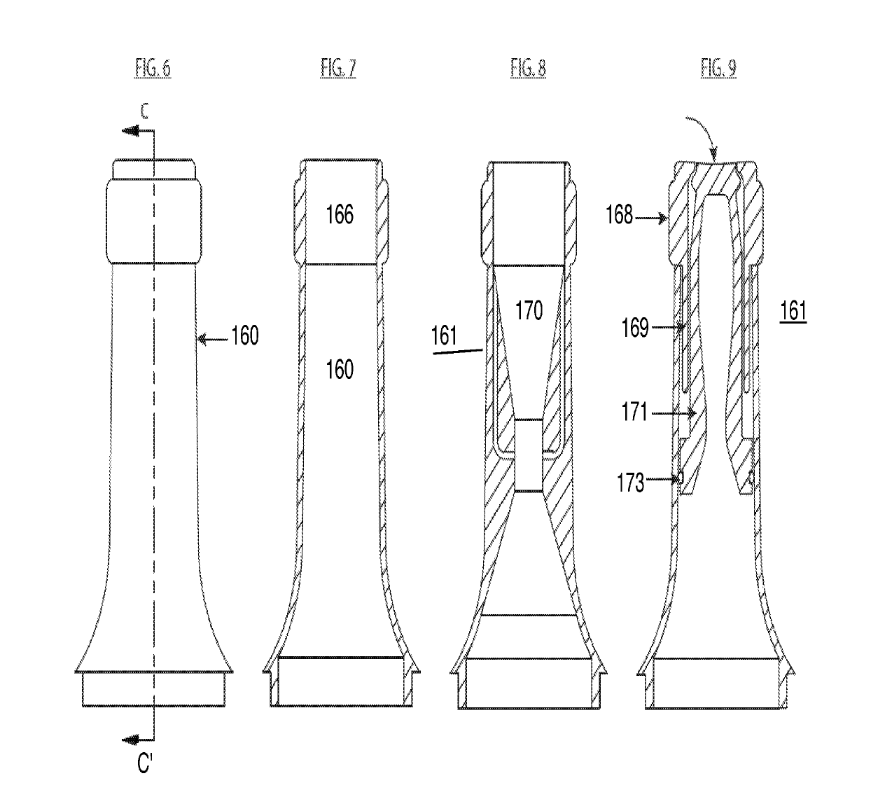

FIG. 7 is a cross-sectional view of the removable top assembly 120 in FIG. 1 taken along line C-C′ in FIG. 6.

FIG. 8 is a cross-sectional view of a first alternative example embodiment 161 of the removable top assembly in FIG. 1 which shows an integrated venturi aeration device 170. This cross-sectional view was taken along line C-C′ in the representative profile view in FIG. 6.

FIG. 9 is a cross-sectional view of a second alternative embodiment 162 of the removable top assembly in FIG. 1 which shows an alternative aeration device 171 with o-ring 173 and pop-up lid 168. This cross-sectional view was taken along line C-C′ in the representative profile view in FIG. 6. In this example, the pop-up lid 168 has an extension, such as a threaded or guided top 169 which operates between the top assembly housing and the aeration device 171. A water-tight seal is formed between pop-up lid 168 and aeration device 171.

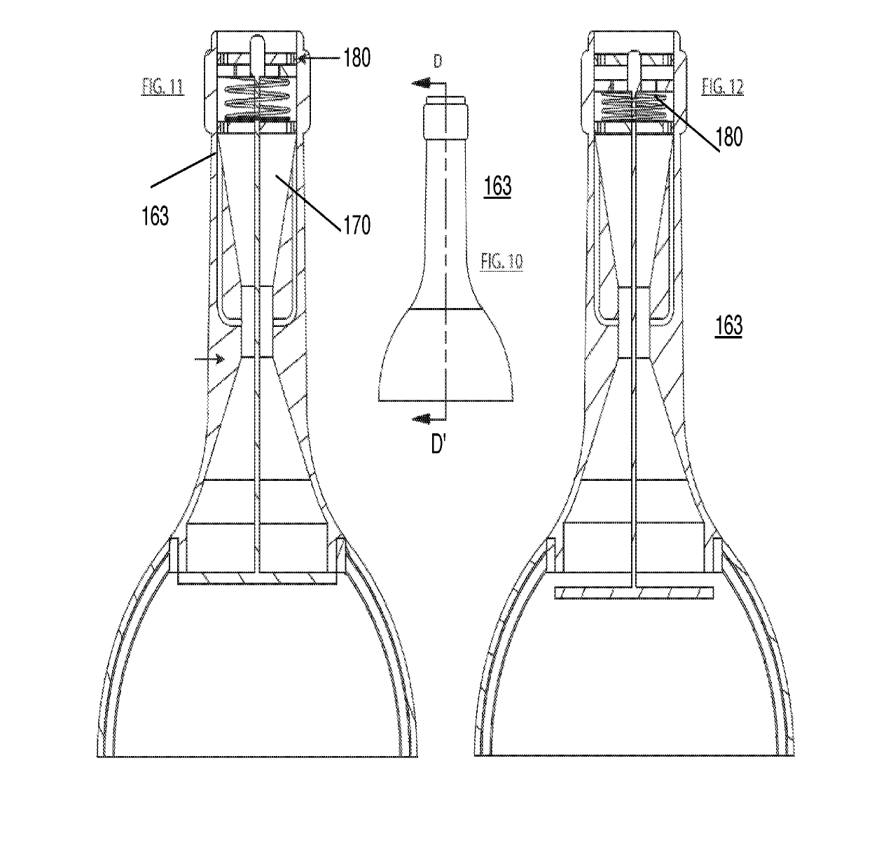

FIG. 10 is a profile view of an alternative embodiment 163 of the removable top assembly in FIG. 1. FIG. 11 is a cross-sectional view of the alternative embodiment of the removable top assembly 163 in FIG. 10 which shows a similar venturi aeration device 170 as shown in FIG. 8 and also a spring-loaded pop-up lid assembly 180 that is in the closed position. This cross-sectional view was taken along line D-D′ in the profile view in FIG. 10. FIG. 12 is a cross-sectional view of the device of FIG. 11 with the spring-loaded lid 180 in the open position.

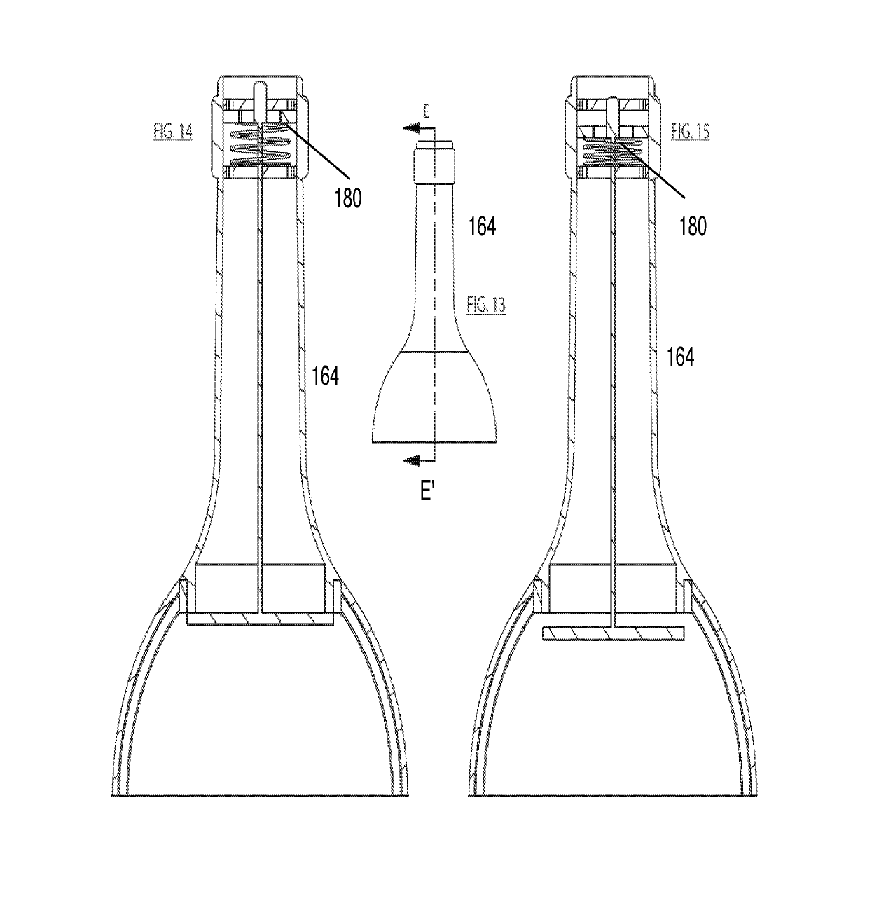

FIG. 13 is a profile view of an alternative embodiment of the removable top assembly 120 in FIG. 1. FIG. 14 is a cross-sectional view of an alternative embodiment 164 of the removable top assembly 120 in FIG. 1 shown with the spring-loaded lid 180 in the closed position. This cross-sectional view was taken along line E in the profile view in FIG. 13. FIG. 15 is a similar cross-sectional view of the alternative embodiment in FIG. 14 with the spring-loaded lid 180 in the open position.

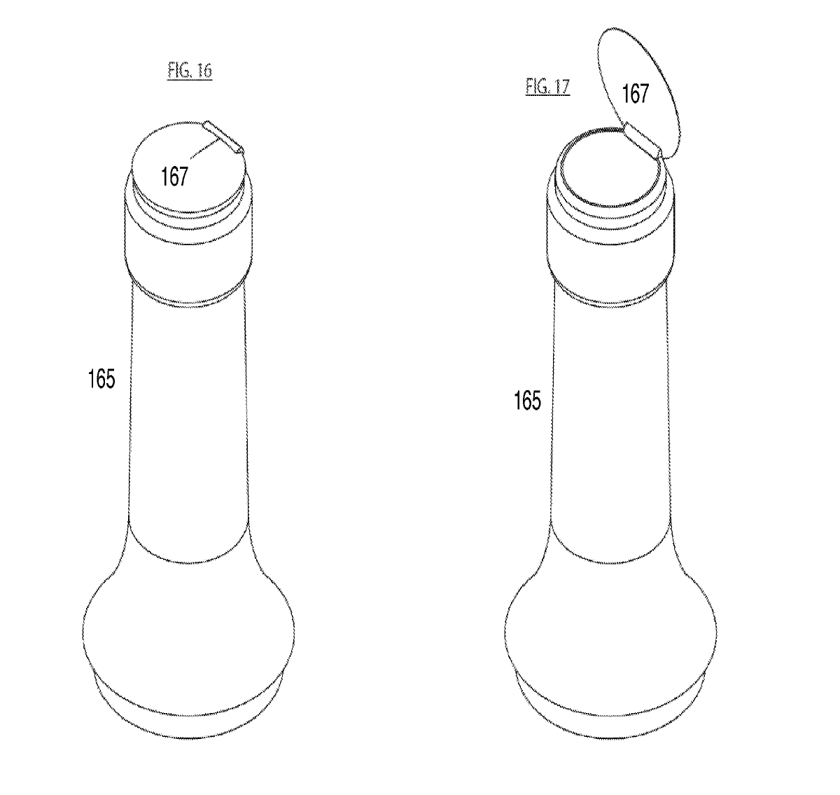

FIG. 16 is a perspective view of an alternative embodiment 165 of the removable top assembly in FIG. 1 shown with a hinged lid 167 in the closed position. FIG. 17 is a perspective view of an alternative embodiment 165 of FIG. 16 with the hinged lid 167 in the open position.

Wine Glass Assemblies

FIG. 18 is a profile view of an embodiment of a wine glass bowl 202. FIG. 19 is a cross-sectional view of the wine glass bowl of FIG. 18. This cross-sectional view was taken along line F-F′ in the profile view in FIG. 18.

FIG. 20 is a profile view of an alternate embodiment of a wine glass bowl 222.

FIG. 21 is a cross-sectional view of the wine glass bowl of FIG. 20. This cross-sectional view was taken along line G-G′ in the profile view in FIG. 20.

FIG. 22 is a profile view of an alternate embodiment of a wine glass bowl 232. FIG. 23 is a cross-sectional view of the wine glass bowl of FIG. 22. This cross-sectional view was taken along line H-H′ in the profile view in FIG. 22.

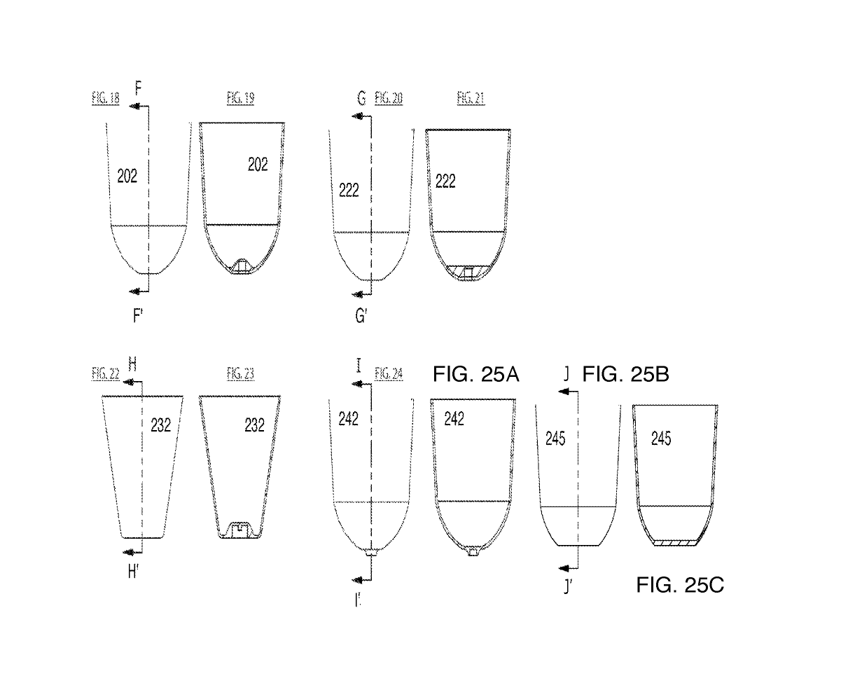

FIG. 24 is a profile view of an alternate embodiment of a wine glass bowl 242. FIG. 25A is a cross-sectional view of the wine glass bowl of FIG. 24. This cross-sectional view was taken along line I-I′ in the profile view in FIG. 24.

FIG. 25B is a profile view of an alternate embodiment of a stemless wine glass bowl 245.

FIG. 25A is a cross-sectional view of a stemless wine glass bowl of FIG. 25B. This cross-sectional view was taken along line J-J′ in the profile view in FIG. 25B.

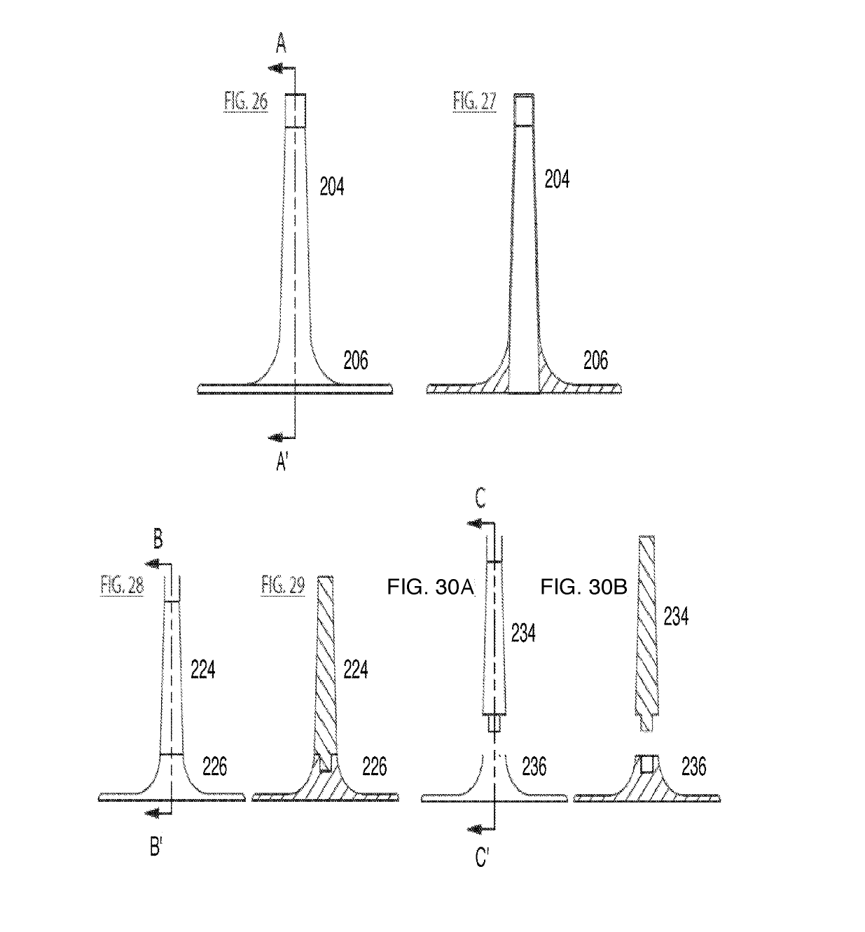

FIG. 26 is a profile view of an embodiment of a wine glass stem 204 and base 206 assembly. In this example, the stem and base are provided as a single part. FIG. 27 is a cross-sectional view of the wine glass stem and base assembly of FIG. 26. This cross-sectional view was taken along line A-A′ in the profile view in FIG. 26.

FIG. 28 is a profile view of an embodiment of a wine glass stem 224 and base 206 assembly. In this example, the stem and base are provided as separate parts. FIG. 29 is a cross-sectional view of the wine glass stem and base assembly of FIG. 28. This cross-sectional view was taken along line B-B′ in the profile view in FIG. 28.

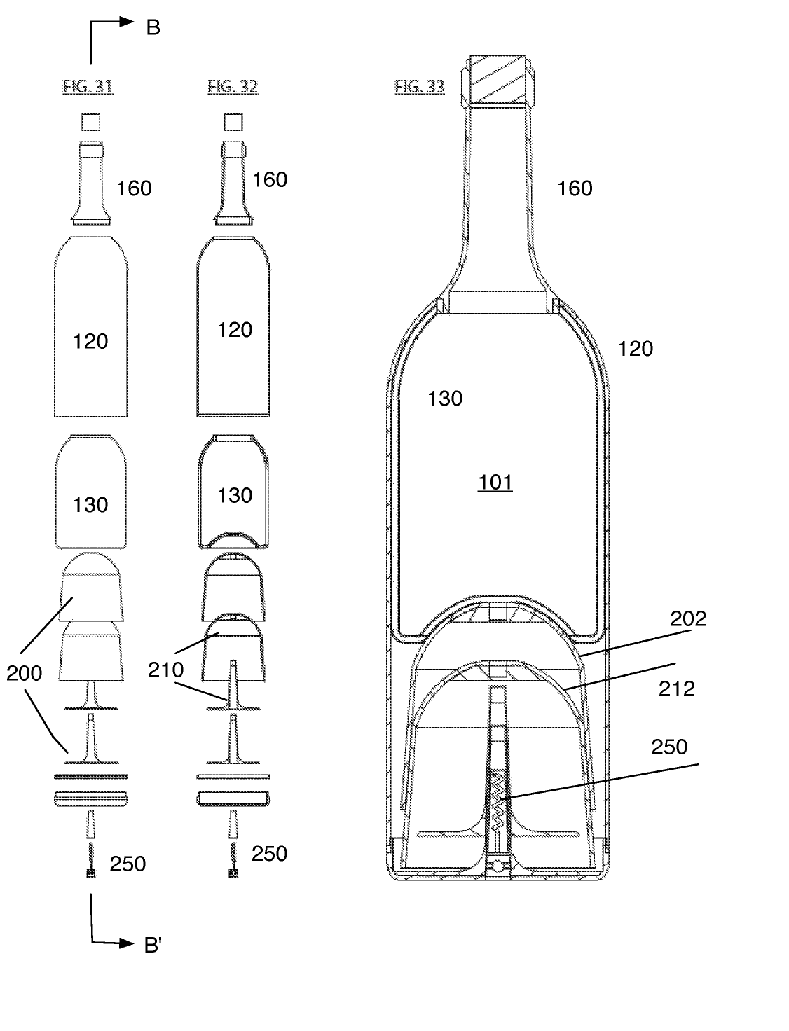

FIG. 30A is a profile view of an embodiment of a wine glass stem 234 and base 236 assembly. In this example, the stem and base are provided as separate parts. FIG. 31 is a cross-sectional view of the wine glass stem and base assembly of FIG. 30. This cross-sectional view was taken along line B-B′ in the profile view in FIG. 30.

Example Device—Valve Cap and Venturi Aeration

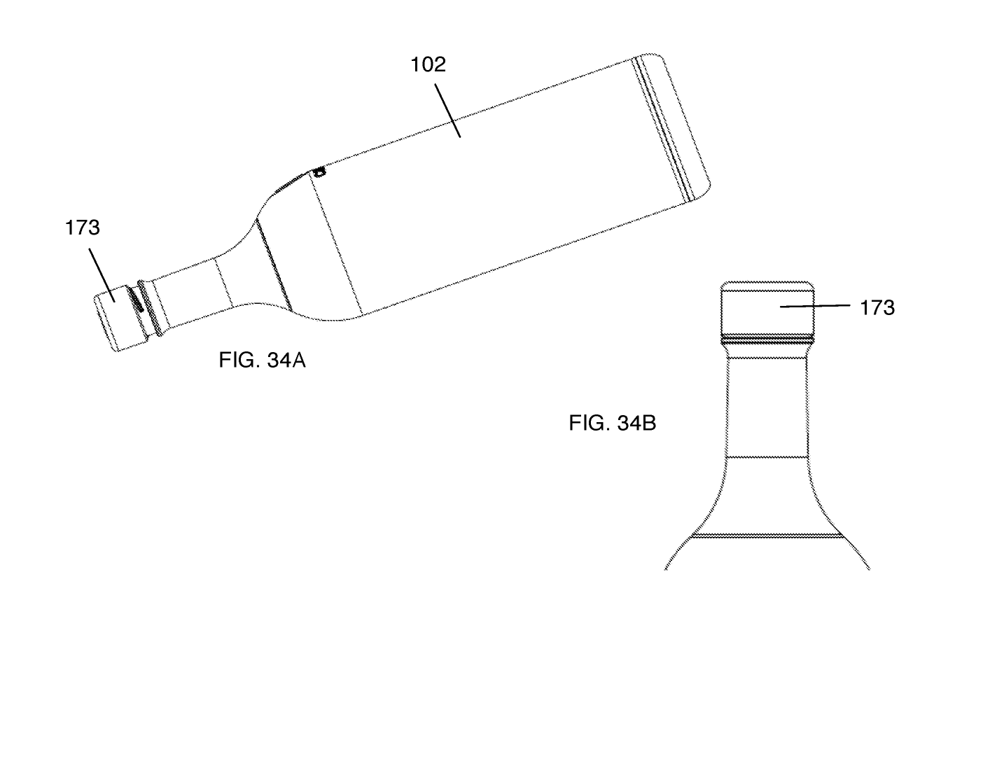

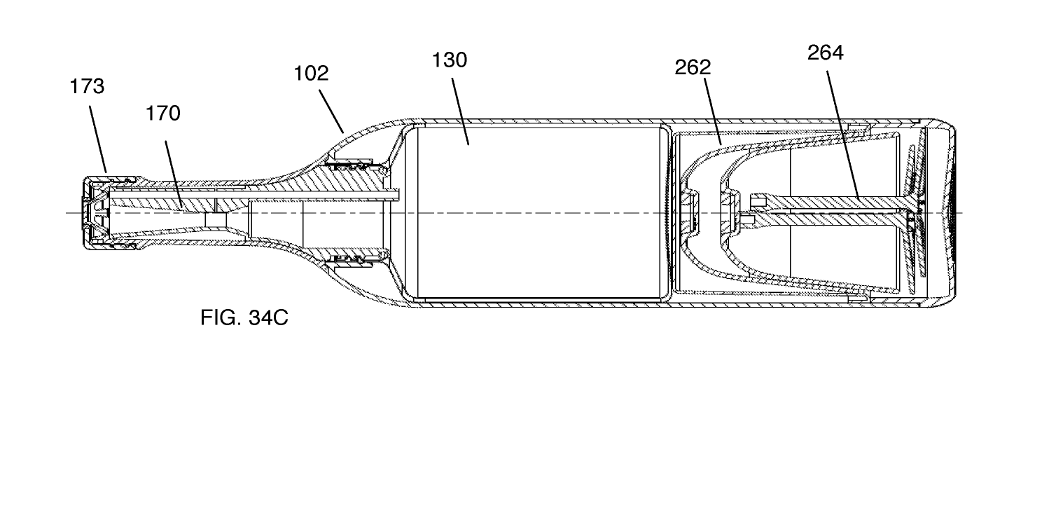

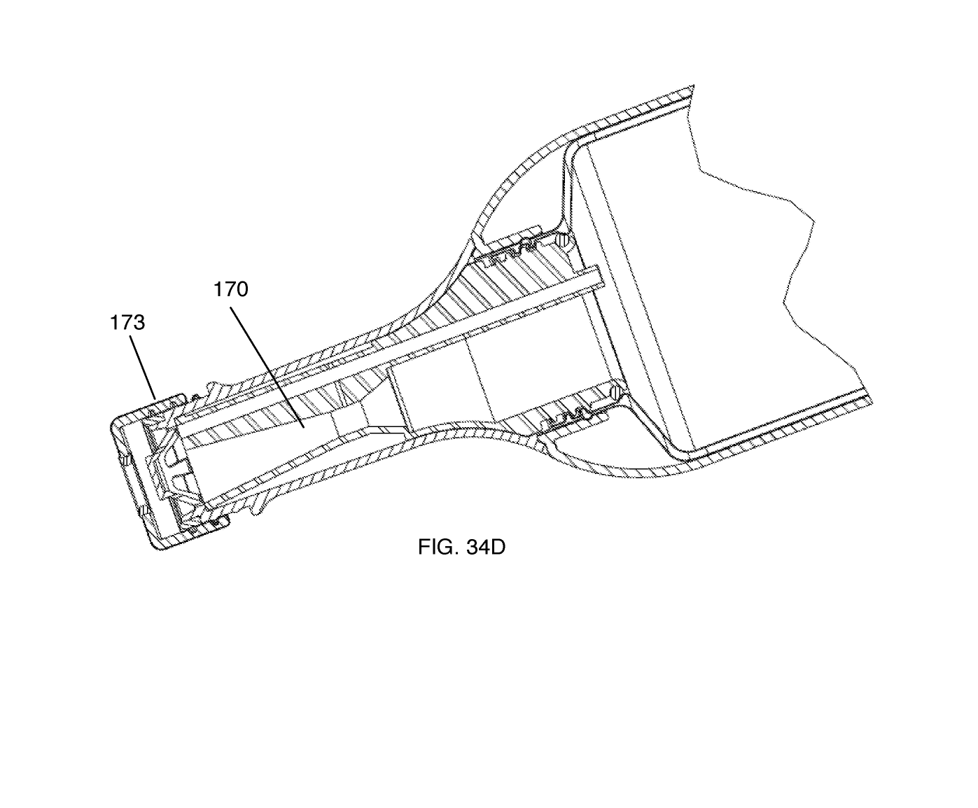

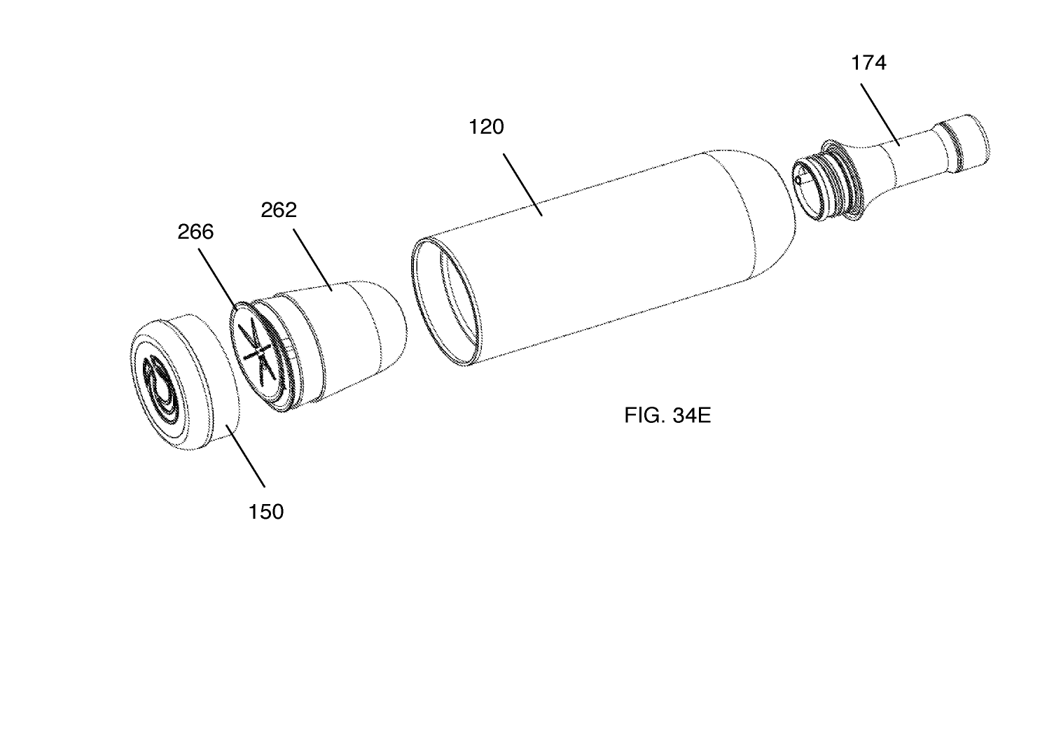

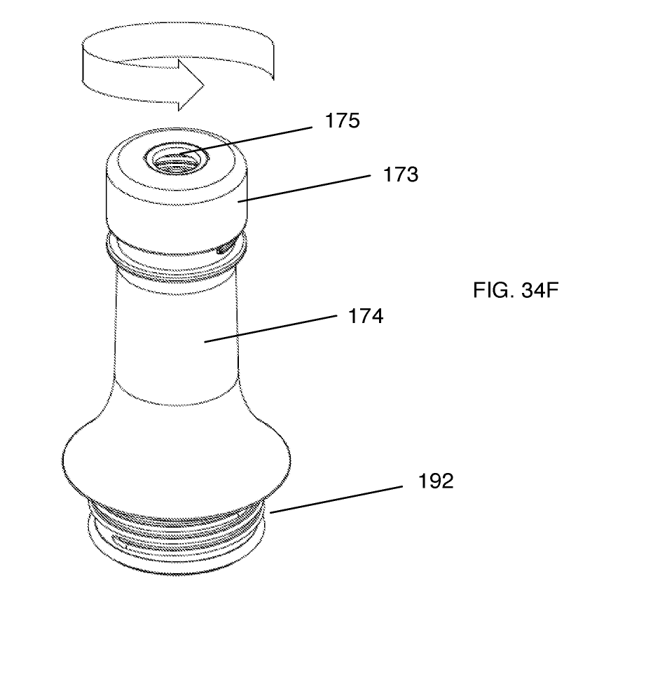

FIGS. 34A-34F show another example embodiment with a valve cap and a venturi aerator.

FIG. 34A is a side view of an example embodiment of a portable storage device 102 in a pouring orientation with a valve cap 173 opened to permit wine to be poured from the device. FIG. 34B is a side detail view of the example embodiment of FIG. 34A with the valve cap 173 closed.

FIG. 34C is a side cross view of the example embodiment of FIG. 34A showing the valve cap 173 and a venturi aerator 170. In this example, the bowl 262 of a first stemmed glass bowl is inverted and stacked on the bowl of a second stemmed glass. In this example, the base of the first wine glass has a hole offset from the stem so that the top of the stem on the second wine glass can be inserted through the hole in order to permit the stem and base assemblies of the first and second wine glasses to be stacked and stored under the inverted stacked bowls of the first and second wine glasses. Thus, in this example, the stems need not be disassembled from the bases. In other examples as shown above, the stems and bases may be disassembled for storage in the storage compartment. In other examples, stemless glasses may be provided.

FIG. 34D is a detailed side cross view of the top portion of example embodiment of FIG. 34A showing the venturi aerator 170.

FIG. 34E is an exploded side view of the example embodiment of FIG. 34A showing the top assembly 174 and base 150 removed from the central housing assembly 120.

FIG. 34F is a side view of top assembly 174 of the example embodiment of FIG. 34A showing the valve cap 173 in an open position so that wine may be poured through a top opening 175 in the valve cap. In this example, threads 192 are provided on the top assembly to secure the top assembly to the insulated chamber (not shown). The large threaded opening in the insulated chamber permits a full bottle of wine to be poured quickly into the insulated chamber.

### Insulated Wine Storage Container with Lower Storage Compartment and Corkscrew Storage

FIG. 31 is an exploded cross profile view of the portable storage device of FIG. 1 taken along line B-B′. is an exploded profile view drawing of the second example embodiment 101 of the portable storage device of FIG. 1. In this example, a corkscrew assembly 250 is stored in the storage compartment.

FIG. 32 is an exploded cross profile view of the portable storage device of FIG. 1 taken along line B-B′.

FIG. 33 is a cross profile view of the portable storage device of FIG. 32A taken along line B-B′.

### Carrier Bag

In this embodiment, a carry bag is provided to hold the device and snacks or accessories. The carry bag will have both a functional and fashion oriented design. The functional design will include a method to secure the bottle; compartments to store accessories such as a cell phone, keys, or other items; and a handle or straps to facilitate ease and convenience of carrying. The fashion design may provide material, patterns, and colors that reflect destination based themes such as bold colors for the beach, luxurious textures for the park, and waterproof linings for the pool. The carry bag may be monogrammed for a user, or for a sponsor such as a resort or winery. The carry bag may be sold separately or as part of a kit including the storage device and accessories.

### User-Filled Method of Use

In this embodiment, the insulated liquid storage compartment 130 holds a typical 750 ml bottle of wine. In other examples, the liquid storage compartment may be larger or smaller than 750 ml. The user selects a wine, and removes the top assembly 160 to expose a large fill opening in the top of the liquid storage compartment. The top assembly may be provided with threads, a quarter-turn closure, compression fit, or other closure element to provide a water-tight seal. The user; pours their selected wine choice through the large opening into the liquid storage compartment; and replaces the top assembly. The device is then transported by grasping the device, or its carry bag.

At a later time or different location, the lower storage compartment is opened by loosening the bottom 150 and lifting the device to expose the cups or glass assemblies. The cups or glass assemblies are removed and assembled if necessary. Wine is poured into each cup or assembled wine glass by opening the top cap 166 or lid 167.

After use, the cups or glasses may be returned to the storage compartment by reversing the procedures used to access the cups or glasses.

### Pre-Filled Method of Use

In this embodiment, a vendor such as a poolside bar, hotel, restaurant, winery, special event, or beach vendor sells, lends, gifts, rents, or any arrangement made between the person consuming the wine and the vendor providing the wine (either as a one-time use or multiple-use scenario) whereby the contents may be pre-filled in advance or on demand as requested by the person consuming the wine. In some examples, the vendor may, as part of their wine offerings or other fluid sale, offer the container to be used by their customer as a means of temporary loan where the container is returned empty to the vendor such that the vendor may provide for the reuse to the same or other customer in a future similar capacity. In other examples, wineries or other merchants may sell the device empty or with contents filled on demand or at an earlier date and the liquid storage compartment is provided with an air-tight seal.

### Pre-Filled; Disposable; One-Time Use

In this embodiment, a vendor such as a large volume winery, pre-fills at a source bottling facility, seals, and transports a shatter-resistant disposable bottle with a lower storage compartment comprising of disposable wine glasses to a retailer such that the contents may be made available in a refrigerated section or shelf for quick and easy access. In some examples, the disposable one-time bottle with a lower storage compartment containing disposable wine glassed may include an aerating element integral to the bottle.

### Restaurant Use of Container with Insulated Chamber and Aeration Element

In some applications, such as restaurants, bars, or outside venues, it is not necessary to store wine glasses in the device. Customers can have an enhanced wine experience by being served wine kept conveniently at a table or location convenient to them in the insulated chamber of a container, and to have the wine aerated by an integral aeration element as the wine is poured. In this example, the customer is able to self-serve wine without the need of a server or waiter, ensured the remaining unopened contents are insulated from external heat, and is aerated as the contents are poured. In this example, the restaurant, bar, or outside venue, is able to offer their customers a personal wine bottle experience, and the restaurant, bar, or outside venue is able to fill the bottle from an secondary external, larger delivery system.

It is to be understood that the specific embodiments and examples described above are by way of illustration, and not limitation. Various modifications may be made by one of ordinary skill, and the scope of the invention is as defined in the appended claims.

What is claimed is:

1. A container for transporting, storing, and dispensing a liquid, the container comprising
a housing comprising
a cylindrical body section having a first diameter,
an upper neck section comprising
a cylindrical bottom with a second diameter smaller that the first diameter,
a top opening having internal diameter, and
an internal channel between the lower portion and the top opening, and
a transition section between the cylindrical body section and the upper neck section,
such that the upper neck section is separable from the cylindrical body section;
an insulated chamber, having a capacity of at least 750 ml, positioned within the cylindrical body section of the housing and having an upper opening aligned with the internal channel of the upper neck section;
an aerating element; and
a cap, lid or valve configured to cover the top opening of the upper neck section.

2. The container of claim 1 wherein
the transition section of the housing comprises
a convex portion integral to the cylindrical body section, and
a concave portion integral to the upper neck section; and
the upper neck section is separable from the cylindrical body section at the intersection of the convex portion of the cylindrical body section and the concave portion of the the upper neck section.

3. The container of claim 1 wherein
the aerating element is a venturi aeration element integral to the upper neck portion.

4. The container of claim 1 wherein
the insulated chamber is a vacuum-sealed insulated chamber positioned within an upper portion of the cylindrical body section.

5. The container of claim 4 further comprising
a storage compartment provided within a lower portion the cylindrical body section of the housing; and
a removable base.

6. The container of claim 5 wherein
the insulated chamber has a concave bottom.

7. The container of claim 4 wherein
the upper neck section has external male threads configured to mate with internal threads provided on the on the insulated chamber.

8. A container kit for transporting, storing, and dispensing a liquid, the container comprising
a container comprising
a housing having a shape suggestive of a large wine bottle, the housing comprising
a cylindrical body section having a first diameter,
an upper neck section comprising
a cylindrical bottom with a second diameter smaller that the first diameter,
a top opening having a top opening having internal diameter, and
an internal channel between the lower portion and the top opening, and
a transition section between the cylindrical body section and the upper neck section,
such that the upper neck section is separable from the cylindrical body section;
an insulated chamber, having a capacity of at least 750 ml, positioned within the cylindrical body section of the housing and having an upper opening aligned with the internal channel of the upper neck section;
a storage compartment provided within the cylindrical body section of the housing;
a cap, lid, or valve configured to cover the top opening of the upper neck section; and
a removable base; and
a first wine glass, the wine glass comprising a first wine glass bowl configured to be storable in the storage compartment.

9. The container kit of claim 8 further comprising
an aeration element.

10. The container kit of claim 9 wherein
the aerator element is a venturi aeration device integral to the upper neck portion.

11. The container kit of claim 8 further comprising
a second wine glass comprising a second wine glass bowl configured to be stacked with the first wine glass bowl, such that the stacked first wine and second glass bowls are storable in the storage compartment.

12. The container kit of claim 8 wherein
the first wine glass has a stem and base assembly, removable from the first wine glass bowl, and configured to be storable in the storage compartment; and
the second wine glass has a stem and base assembly, removable from the second wine glass bowl, and configured to be storable in the storage compartment.

13. The container kit of claim 12 wherein
the base of the first wine glass stem and base assembly is removable from the stem of the first wine glass stem and base assembly; and
the base and the stem of the first wine glass stem and base assembly are configured to be storable in the storage compartment.

14. The container kit of claim 8 further comprising
a wine bottle opener storable in the storage compartment.

15. The container kit of claim 8 further comprising
a carry bag configured to hold the container and other items.

16. A method for transporting, storing, and dispensing wine, the method comprising
providing a container comprising
a housing having a shape suggestive of a large wine bottle, the housing comprising
a cylindrical body section having a first diameter,
an upper neck section comprising
a cylindrical bottom with a second diameter smaller that the first diameter,
a top opening having a top opening having internal diameter, and
an internal channel between the lower portion and the top opening, and
a transition section between the cylindrical body section and the upper neck section,
such that the upper neck section is separable from the cylindrical body section;
an insulated chamber, having a capacity of at least 750 ml, positioned within the cylindrical body section of the housing and having an upper opening aligned with the internal channel of the upper neck section;
a cap or lid configured to cover the top opening of the upper neck section; and
a removable base, and
an aeration element;
transporting the container to a second location; and
pouring a portion of the wine or other liquid from the insulated chamber.

17. The method for transporting, storing, and dispensing wine of claim 16 wherein filling the insulated chamber with wine or other liquid at a first time and location further comprises
pouring a bottle of wine into the insulated chamber.

18. The method for transporting, storing, and dispensing wine of claim 16 further comprising
providing a storage compartment within the cylindrical body section of the container housing;
storing a pair of wine glasses in the storage compartment; and
removing the pair of wine glasses from the storage compartment at the second location.

19. The method for transporting, storing, and dispensing wine of claim 18 wherein
storing a pair of wine glasses in the storage compartment further comprises storing a pair of disassembled wine glasses; and
removing the pair of wine glasses from the storage compartment at the second location further comprises assembling each of the pair of wine glasses.

20. The method for transporting, storing, and dispensing wine of claim 19 wherein
storing a pair of wine glasses in the storage compartment further comprises storing a pair of disassembled wine glasses further comprises
storing a first disassembled wine glass comprising
a first bowl, and
a first base with a first integral stem, and
storing a second disassembled wine glass comprising
a second bowl, and
a second base with a second integral stem, such that the first base has a hole offset from the first integral stem, and the second integral stem is inserted through the hole, thereby stacking the first base on the second base.
